(19) United States
(12) Patent Application Publication
(10) Pub. No.: US 2022/0278580 A1
(43) Pub. Date: Sep. 1, 2022

(54) Three pulse, odd-even motor winding system

(71) Applicant: Sten R. Gerfast, Mendota Heights, MN (US)

(72) Inventor: Sten R. Gerfast, Mendota Heights, MN (US)

(21) Appl. No.: 16/873,513

(22) Filed: Apr. 27, 2020

(51) Int. Cl. H02K 3/28; H02K 17/08; H02K 1/2753; H02P 25/04

(52) U.S. Cl. CPC H02K 3/28; H02K 17/08; H02K 1/2753; H02P 25/04

(57) ABSTRACT

A motor winding and energizing system using a “Three pulse, odd-even motor winding” wherein first, all odd numbered coils and then all even numbered coils, are wound on a motor stator, and a rotor having alternate polarity magnetic poles, with the rotor rotatably journaled inside the stator. The rotor is having the same number of poles as the total number of coil poles. When an original power pulse is connected to odd coils, out-of-phase induction pulses also occur into adjacent even-numbered coils. thereby diminishing the original power pulse, and the wattage associated with it, causing the rotor, to rotate by the said three pulses, but at a diminished wattage. The motor can have only one, or two or more semiconductors to drive the coils. The motor can have a “magnetic start “position” Alternators and generators can also be altered to benefit by this new winding system. Motors, which can be fractions of HP, can also designed for hundreds of HP.

### BACKGROUND

Early electrical devices, such as motors, were using a Three Phase AC sine wave generated at a power plant. The three-part sine wave with peaks at every 120 degrees, and with an induction rotor were smooth running. A split phase motor with one of its windings having a low resistance start winding, which was switched out of the circuit after start, was a popular motor construction. An induction motor, again with an induction rotor, was an in-expensive and another very common motor. A variation of this design was designed as a shaded pole motor, for vey low power application's, but also had a very reasonable cost. Another variation, also with an induction rotor, was the Permanent Split Capacitor motor, which was designed with two phases, one phase using the AC line, and a capacitor phase. These two phases made the design self-starting.

Increased concern for more efficiency brought the Brushless motor which replaced the induction rotor with a permanent magnet rotor, with the magnets being part of the torque production, but also giving higher efficiency. But, for the first time, an expensive circuit-board-drive-circuit was required. Most early brushless motors were designed as a Tree Phase motor with three rotation sensors and six transistors to switch the Direct current, derived from AC with rectification and capacitor smoothing. The circuit board and the extra components made this motor much more expensive than the induction motors.

Brushless motors typically have a different number of stator poles versus rotor poles. Different pairings of stator poles versus rotor poles such as 6-8. 12-8, 4-6, 6-2 are used by different designers, but did not make these motors any less expensive.

Another design of a brushless motor is using a single coil, direct current permanent magnet rotor in the motor, including an internal rotor with six alternately polarity magnets rotatably journaled in the motor, and an external stator with six salient poles, including six alternately wound coils coupled to form a single coil with two free ends. This motor uses a commutated H-bridge having a voltage boost circuit with capacitors providing a boosted voltage to alternately turn on high side switches of the H-bridge, wherein the capacitors are charged by a charging current flowing trough low-side switches.

This describes some of the design in the brushless area, but not all, of the prior art. Some of the newer designs of a rotor, uses neodymium magnets, which are some of the strongest flux producers known. They can be used on the outside of the rotor, or as an alternate, embedded in an iron rotor. The embedded magnets can have many design concepts, such as v-shaped opening in the rotor body or straight line insertion into the rotor. Neodymium cost, at the present time is at least twice the cost of ceramic magnets. Since all design have to have a conserns about costs, the added cost, should equal increased performance, or it would not be considered for new rotor designs.

This according to formulas, one basic one is stated above.

The induction principles are used to design: Induction motors, split phase motors, permanent split capacity motors, (P. S. C), and Shaded coil motors. Another type of motors are not using the induction principle, because the market place is demanding higher efficiency. Brush-less motors are not using induction rotors, but instead is using permanent magnet rotors. These motors do use magnets on the rotor to co-act with the basic stator poles, wound with magnet wires, pretty much as the same induction stators that are described above. When the wound stator poles are supplied with pulses they attract or repel rotor magnets according to the stator winding polarity,

A different design, known as a 3 phase drive circuit, is including three rotation sensors and six transistors to switch a direct current into the stator. Current flows through two of the three coils or phases at any one time. Therefore, a three phase motor with three coils only utilizes approximately two-thirds of the copper windings at one time.

Such a configuration can provide a smooth drive and good stating torque, but is complicated in terms of of the number of components and the expense of the components. Other similarly designed motors including different pairings of stator poles versus rotor poles (e.g., 6-8, 12-8, 4-6. 6-2) are also complex and expensive.

The above described prior art devises need to be redesigned for easier manufacture and decreased parts costs.

The present invention is doing that with a unique winding system and pulsing system.

The present invention.

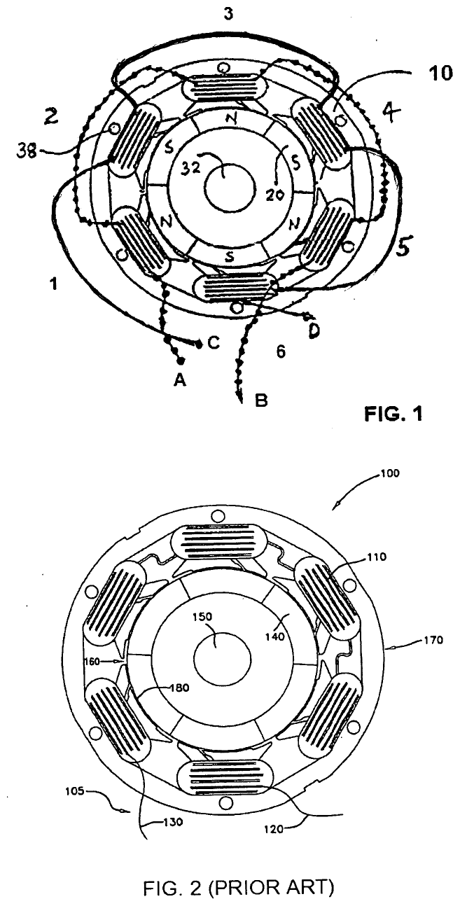

The present invention is using a fact that when a structure, such as shown in FIG. 1, is first connected with all odd numbered coils and then all even numbered coils, and the coils are wound consecutively on a motor stator with certain switching, it is more efficient then prior art.

The odd coils are interacting with even numbered coils when an original power pulse is connected to the odd coils,

out-of-phase induction pulses also occur into adjacent even-numbered coils.

This interaction is utilized to divide input power into the odd poles and out of phase adjacent even poles. This division into tree pulses, is providing a more efficient interaction with a closely spaced rotor. The rotor is having the alternate polarity magnets closely spaced mechanically, and is interacting with the stator. Pulses into the stator in a consecutive order, is causing rotation of the rotor, and thereby provide an more efficient power production, with less input watts into the motor.

The out of phase induction into adjacent pole sections when a pulse is introduced into a center section is a known fact, and is well described in transformer articles or books. This interaction is quite efficient, and can easily have an 85 percent efficiency. In this instant, the magnetic interaction of a moving permanent magnet rotor, with the correct polarity in front of the three induction poles, with alternate polarity, is also a factor.

This invention is using this un-usual internal self-induction principle!

This mutual interaction of induction, L and capacitance C, (of a possible smoothing capacitor in a power supply), can have many dynamic resonance points, or phase differences, which are also dependent on component values, superposed on rotor velocity, and the other motor values, and is more efficient in general, and also is more efficient at certain rotor rotations, or resonance points. Therefore, this invention can be more efficient at certain rotations, or resonance values, depending on its physical size, and the structure of the unit, as well as component values.

A start-position of the rotor, wherein the rotor's rotation is stopped, is achieved by an extra magnet. The rotors angular stop position is controlled by a permanent magnet, attached to a specific stator pole, and attracting a specific rotor pole, and wherein the described angular position also is the motors start-position.

Most motors of this category are driven by DC, but can also be driven by AC pulses. or diode rectification of AC, and then having a smoothing capacitor to smooth out the rectified AC pulsations.

There is some interesting fact to be researched in a 3 phase, induction, split phase or capacitor motors using the described odd-even winding system. This can be a new type of winding of any electric motor.

Even though the described patent application, and its prototypes, have been in the fractional horsepower range, this type of winding can be used in motors having hundreds of HP.

### DESCRIPTION OF THE INVENTION.

FIG. 1 is showing a stator and rotor combination with the unique winding sequence.

FIG. 2 is showing a circuit that could used to drive this invention.

FIG. 3 is showing a possible control for power and speed, that could be used by motor customers even after the installation of the motor.

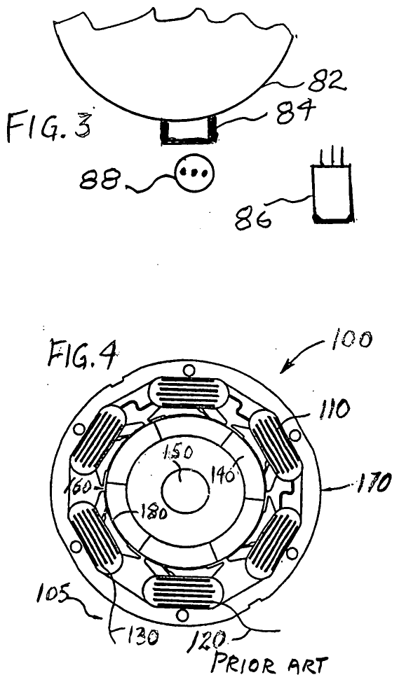

FIG. 4 is the inventors prior art design and drawing.

### DETAILED DESCRIPTION OF THE INVENTION

FIG. 1 is showing a basic form of the invention, but modifications of this, can also be made.

The stator has output leads from coil 1 coil 3 and coil 5, odd number coils, marked A and B.

The stator also has output leads from coil 2 coil 4 and coil 6, even number coils marked C and D.

This un-usual winding sermence has not been used in the motor industry in the past, as far as the inventor has been able to determine.

FIG. 2 is showing a basic circuit 60 that can be used to drive odd number of coils A and B using a mosfet 62 (metal oxide field effect transistor) for driving A and B.

A Magnetic sensor 64 (Hall sensor) to provide a pulse, which is steering its output signal to the mosfet, which is then driving coils A and B.

A signal 66 (also from the Hall sensor,) but inverted by an inverter 68 is alternately driving coils C and D. The Hall sensor 64 is located in the correct spot in front of the rotor poles, (not shown in this drawing) South and North poles magnets for the correct timing of when to turn on the correct coils.

This circuit can be driven by DC current at point 70, or can be derived from a rectifier full bridge circuit, with a smoothing capacitor. Minor other components are used, but not numbered.

FIG. 3 is showing a possible control or power and speed that could be used by motor customers even after the installation of the motor 82. A capacitor 86 shown in front view at 88, can either be plugged into port 84 or not, to control speed.

FIG. 4 is showing the inventors prior art design and drawing.

1. Three pulse, odd-even motor winding system comprising:
first, all odd numbered coils and then all even numbered coils, are wound consecutively on a motor stator, a rotor having alternate polarity magnetic poles,
with the rotor rotatably journaled inside the stator,
the rotor having the same number of poles as the total number of coil poles,
wherein, when an original power pulse is connected to odd coils,
out-of-phase induction pulses also occur into adjacent even-numbered coils,
thereby diminishing the original power pulse by this phase-difference,
and the wattage associated with it, causing the rotor to rotate by the said three pulses, but at a diminished wattage,
as compared to switching of pulses into a total number of coils, at one time.

2. Three pulse, odd-even motor winding system according to claim 1
wherein the motor stator is having any number, and the rotor is having any number and wherein the inductance and resistance of the coil winding of the motor stator is determined by the number of turns of windings and the diameter of wire that is wound, and the stators physical dimensions, as well as the frequency of the original power pulse, and, also is dependent on a power supplies voltage, and its smoothing capacitors used for the motor, wherein all of the above, also determines the RPM of the rotor, and the motors efficiency.

3. Three pulse, odd-even motor winding system according to claim 2 wherein coil inductance is designated Lr wherein the subscript r is the coil resistance, capacitance is designated as C, and input power pulses are described as volt×amps=input watts, and the rotor rotation is designated as RPM. and input power frequency is designated as Hz, and the output power is W as in Watts.

4. Three pulse, odd-even motor winding system according to claim 1
wherein, when original power pulses are connected to odd coils,
the rotors rotation is caused by original pulses and induction pulses from two adjacent poles, and wherein pulses occur consecutively in all of the mentioned total coils,
at a diminished input wattage, as long as pulses are applied according to claim 1, thereby saving watts of energy.

5. Three pulse, odd-even motor winding system according to claim 1 wherein
first, all odd numbered coils and then all even numbered coils, are wound on a motor stator,
wherein, when an original power pulse is connected to odd coils,
out-of-phase induction pulses also occur into two adjacent even-numbered stator coils,
causing the rotors rotation by original pulses and pulses from two adjacent poles,
which are occurring continuously in all of the mentioned total coils, at a diminished wattage,
with pulses being further modified by the rotor magnets rotating in front of all stator coils,
as long as pulses are applied to the coils, thereby saving watts of energy.

6. Three pulse, odd-even motor winding system according to claim 1
wherein semi-conductors are creating the pulses, using either one or two semi-conductors to execute the above creating of pulses,
wherein a driving circuit for switching is having semi-conductors of different types, such as mosfets, transistors, IGBT, SCR or triac's.

7. Three pulse, odd-even motor winding system according to claim 1
wherein pulse switching into odd-numbered stator poles equals poles 1, 3, and 5 and secondly into poles 2, 4, and 6, in a six-pole machine,
and 1, 3, 5 and 7 and 2, 4, 6, and 8 in an 8-pole machine,
and 1, 3, 5, 7, 9, 11 and secondly 2, 4, 6, 8. 10, 12 into a 12-pole machine as well as 1, 3 and 2, 4 in a 4-pole machine, and so on.

8. Three pulse, odd-even motor winding system according to claim 1
wherein pulse switching into odd-numbered stator poles equals poles 1, 3, and 5
wherein these three poles are connected in series or in parallel, and secondly into poles 2, 4, and 6,
wherein these three poles are connected in series or parallel, all describing connections in a six-pole machine.

9. Three pulse, odd-even motor winding system according to claim 1
wherein the pulse-switching is a current of DC (direct current) or AC (alternating current), AC (alternating current) rectified into DC current, smoothed by a capacitor,
and wherein the RPM rotation, can be changed by the microfarad value of the capacitor.

10. Three pulse, odd-even motor winding system according to claim 9
wherein the rotor RPM rotation is controlled by one capacitor for one rotation, or RPM, two capacitors for two RPM, or having multiple capacitors for several numbers of RPM's.

11. Three pulse, odd-even motor winding system according to claim 1
wherein the motor winding system is for a brushless motor, alternator, generator, stepper motor, permanent split capacitor motor or an actuating rotating device.

12. Three pulse, odd-even motor winding system according to claim 1
wherein the timing of when the switching is to occur, is controlled by a Hall sensor, having two outputs, connected into two semi-conductors.
or a Hall sensor having a single output connected into one semi-conductor.
and an inverter, used by a second semi-conductor to alternately drive the same coil, and wherein the Hall sensor is placed physically at the center-line between two poles, plus 7 degrees for clock-wise rotor rotation or minus 7 degrees for counter-clockwise rotation, wherein the center-line or neutral position is determined by where the two exit leads, start lead and finish lead are emanating from the wound stator.

13. Three pulse, odd-even motor winding system according to claim 12 wherein the Hall sensor is only having a single output, controlling turn-on when the rotor's rotation is stopped, and wherein the rotors angular stop position is controlled by a permanent magnet, attached to a specific stator pole, and attracting a specific rotor pole, and wherein the described angular position also is the motors start-position.

14. Three pulse, odd-even motor winding system wound consecutively comprising:
first, all odd numbered coils and then all even numbered coils, are wound consecutively on a motor stator, a rotor having alternate polarity magnetic poles,
with the rotor rotatably journaled inside the stator,
the rotor having the same number of poles as the total number of coil poles,
with semi-conductors creating pulse-switching,
switched as a sequence into the wire-wound stator poles,
firstly, pulse-switching into odd-numbered stator poles,
secondly, pulse-switching into even-numbered stator poles,
wherein this switching results in a continuing rotation of the rotor,
needing only two semi-conductors to execute the switching. 15 Three pulse, odd-even motor winding system according to claim 14, with a driving circuit for switching, having semi-conductors of different types, such as mosfets, transistors, IGBT, SCR or triac's, or integrated circuits.

16. Three pulse, odd-even motor winding system according to claim 14, wherein the winding system can be used on a fraction of a horsepower or several multiple horsepower devices

17. Three pulse, odd-even motor winding system according to claim 1, wherein even numbered stator coils, are paired with rotor poles having a different number, such as 6 rotor poles and 8 stator poles, similar to a three-phase motor system

18. Three pulse, odd-even motor winding system according to claim 1, wherein this system Is used to modify a 3-phase motor running on AC or DC, a split phase motor with modified odd-even coil structure, a permanent capacitor motor with modified odd-even coil structure, an induction motor to be modified with odd-even coil structure, or a 4 semi-conductor bridge drive motor, to increase the efficiency of these devices.

19. Three pulse, odd-even motor winding system according to claim 14, wherein this winding system Is used to modify a motor, alternator or generator using either a rotor with slip-rings, or a rotor with permanent magnets, with the modified odd-even coil system used to increase efficiency.

20. Three pulse, odd-even motor winding system according to claim 14, wherein this winding system is used to modify a motor, alternator or generator using either an induction type rotor, or a rotor with permanent magnets, with stators windings which can produce hundreds of HP.
